(19) United States
(12) Patent Application Publication
(10) Pub. No.: US 2020/0380518 A1
(43) Pub. Date: Dec. 3, 2020

(54) SYSTEMS AND METHODS FOR USING A VEHICLE AS MULTIPLE IDENTITIES

(71) Applicant: Wells Fargo Bank, N.A., San Francisco, CA (US)

(72) Inventors: Margaret S. Honeycutt, Crockett, CA (US); David Newman, Walnut Creek, CA (US); Ramanathan Ramanathan, Bellevue, WA (US); William Ward Sutton, Walnut Creek, CA (US); William Wheeler, San Francisco, CA (US)

(21) Appl. No.: 15/349,463

(22) Filed: Nov. 11, 2016

Related U.S. Application Data
(60) Provisional application No. 62/255,854, filed on Nov. 16, 2015.

(51) Int. Cl. G06Q 20/40; G06Q 10/10; G06K 7/10

(52) U.S. Cl. CPC G06Q 20/4014; G06K 7/10366; G06Q 10/1095

(57) ABSTRACT

A vehicle occupant identity system or device for facilitating a merged vehicle identity comprising one or more passenger identities is described along with a financial institution computing system. The device is integrated in the vehicle or is a separate device positioned in or on the vehicle. The device identifies and authenticates one or more individuals inside the vehicle or in close proximity. In some arrangements, the device adjusts restrictions and permissions related to using the vehicle depending on the identity of the occupants. In some arrangements, the occupant identity device uses an additional source of information to detect the reason for the trip inside the vehicle and adjusts storing of historical information along with adjusting restrictions and permissions. In some arrangements, the device stores financial information associated with the identities of the occupants of the vehicle allowing for payment of goods or services received from a merchant.

### CROSS-REFERENCE TO RELATED APPLICATIONS

This application claims priority to U.S. Provisional Patent Application No. 62/255,854 entitled “SYSTEMS AND METHODS FOR USING A VEHICLE AS MULTIPLE IDENTITIES,” by Honeycutt et al., filed on Nov. 16, 2015, which is herein incorporated by reference in its entirety and for all purposes.

### BACKGROUND

Vehicles may be used in different ways depending on who is operating the vehicle. For example, a single vehicle may be used for individual use, family use, and business use. Vehicle owners and operators routinely pay for food and services associated with usage of the automobile, such as fuel, tolls, food and the like. Vehicle owners may use a credit card or other payment method in order to facilitate payments for goods and services related to automobile use. Some systems allow for payment methods to be linked to specific vehicles. For example, a driver can place a toll transponder on or in his or her vehicle such that when the vehicle passes through an automated tool booth, the toll booth scans the toll transponder (e.g., via RFID communication) and bills the payment method associated with the toll transponder (e.g., a credit card).

### SUMMARY

One embodiment relates to a vehicle occupant identity system for use with a vehicle. The system includes a network interface, a computer memory for storing identity information, at least one processor, and a display. The processor or processors execute operations to detect a presence of an individual in or in close proximity to the vehicle, determine the identity of the individual based at least on the stored identity information, receive an additional source of information via the network interface from a device associated with the individual, and use the additional information to identify a reason for taking a trip or otherwise using the vehicle. Authentication takes place by having the system in the vehicle communicate with a mobile device carried by the individual. The system also includes a touchscreen for user input. The additional source of information may be an electronic calendar, electronic appointment book or the like. The one or more processors may further execute operations to detect when an emergency situation is taking or has taken place and transmit information regarding the emergency situation to an outside source.

Another embodiment is a method for using a vehicle occupant identity system in a vehicle or in proximity to a vehicle. The method includes detecting, by a processor of the occupant identity system, a presence of an individual within the vehicle. Determining the identity of the individual is done at least in part by use of the stored identity information accessed by the system. Additional information is received via a network interface from a device associated with the individual. The method further includes identifying a purpose for the trip in the vehicle by using the additional information and configuring a setting of the vehicle based on the purpose and the identity of the individual. The additional source of information may be an electronic calendar, electronic appointment book or the like. The method my further include detecting an emergency situation and transmitting information comprising the existence of the emergency situation to an outside source. The information transmitted to the outside source may contain at least one of the identities of the individuals in the vehicle.

A further embodiment relates to a non-transitory computer-readable media having computer-executable instructions embodied therein that, when executed by one or more processors of a vehicle occupant identity system for use with a vehicle, cause the system to perform a process. The process includes detecting, by a processor of the occupant identity system, a presence of an individual within the vehicle. Determining the identity of the individual is done at least in part by use of the stored identity information accessed by the system. Additional information is received via a network interface from a device associated with the individual. The method further includes identifying a purpose for the trip in the vehicle by using the additional information and configuring a setting of the vehicle based on the purpose and the identity of the individual. The additional source of information may be an electronic calendar, electronic appointment book or the like. The method my further include detecting an emergency situation and transmitting information comprising the existence of the emergency situation to an outside source. The information transmitted to the outside source may contain at least one of the identities of the individuals in the vehicle.

Another embodiment relates to a method of using a vehicle occupant identity system in a vehicle. The method includes detecting, by a processor of an occupant identity system, a presence of an individual within the vehicle. The method further includes determining an identity of the individual based at least in part on stored identity information. The method includes configuring a payment source associated with the vehicle based on the identity of the individual.

These and other features, together with the organization and manner of operation thereof, will become apparent from the following detailed description when taken in conjunction with the accompanying drawings, wherein like elements have like numerals throughout the several drawings described below.

### BRIEF DESCRIPTION OF THE FIGURES

FIG. 1 is a diagram of an occupant identity system environment shown according to an example embodiment.

FIG. 2A is a flow diagram of a method of authenticating an individual who has entered a vehicle shown according to an example embodiment.

FIG. 2B is a diagram of a display depicting levels of access granted to users of a vehicle with an occupant identity system shown according to an example embodiment.

FIG. 3 is a flow diagram of a method of detecting the purpose of a vehicle trip shown according to an example embodiment.

FIG. 4 is a flow diagram of a method of contacting emergency services using an occupant identity system in a vehicle shown according to an example embodiment.

FIG. 5 is a flow diagram of a method of sharing costs incurred in a vehicle with an occupant identity system shown according to an example embodiment.

### DETAILED DESCRIPTION

Referring generally to the figures, an occupant identity system for facilitating identifying one or more passengers or users of a vehicle is described. The occupant identity system is integrated in the vehicle or is a separate device positioned in or on the vehicle. The occupant identity system identifies and authenticates one or more individuals inside the vehicle or in close proximity to the vehicle. In some arrangements, the vehicle occupant identity system stores financial information associated with the occupants of the vehicle, which allows for payment of goods or services received from a merchant or service provider to be attributed to the actual occupants of the vehicle.

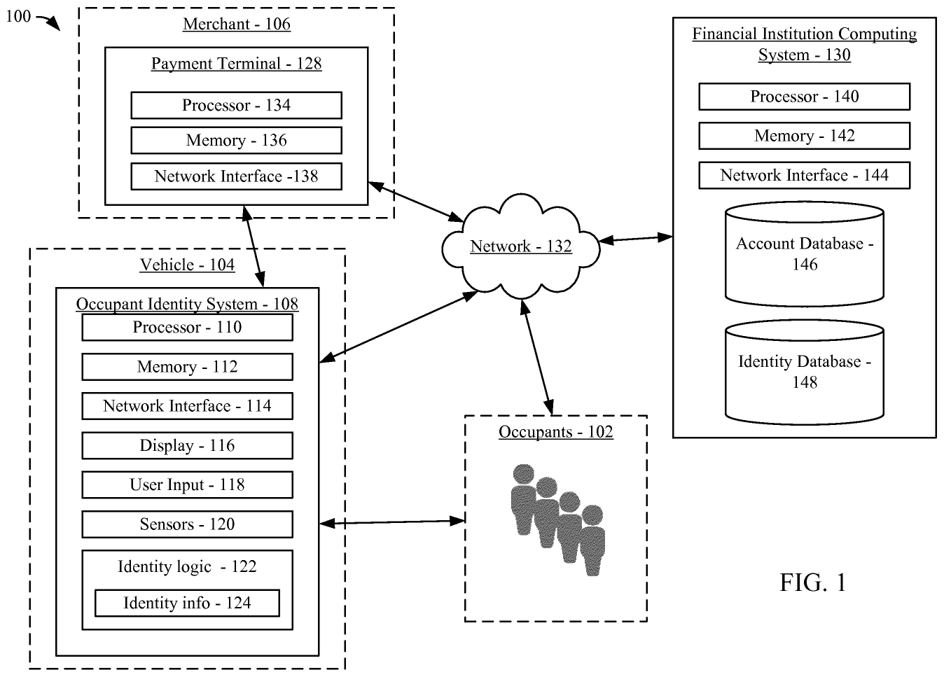

Referring to FIG. 1, a diagram of a system 100 is shown according to an example embodiment. As described in further detail below, the system 100 facilitates supporting the use of a vehicle 104 in both personal and business settings where the identities of the drivers and the passengers (i.e., the occupants 102) of the vehicle 104 define a vehicle identity. The system 100 includes an occupant identity system 108. The occupant identity system 108 is positioned in or on the vehicle 104. For example, the occupant identity system 108 may be an electronic device secured to a dashboard or window of the vehicle 104. In other arrangements, the occupant identity system 108 is integrated into the vehicle 104. In such arrangements, the occupant identity system 108 may be integrated into the infotainment system (e.g., navigation system, media playing system, etc.) of the vehicle 104. Alternately or in addition to the above-described such arrangements, the occupant identity system 108 is connected to the engine control unit (ECU) of the vehicle 104. The occupant identity system 108 is connected to the ECU directly or through a controller area network (CAN). Generally, the occupant identity system 108 serves as a vehicle user or occupant identification device, a security device, and a payment device for the occupants 102 of the vehicle 104.

The occupant identity system 108 includes a processor 110 and memory 112. The memory 112 stores programming modules that, when executed by the processor 110, control the operation of the occupant identity system 108. In certain arrangements, the processor 110 and the memory 112 are also associated with the infotainment system of the vehicle 104. The occupant identity system 108 includes a network interface 114. As described in further detail below, the network interface 114 allows the occupant identity system 108 to send and receive data to and from various devices, such as mobile devices associated with the occupants 102, a merchant payment terminal 128 associated with a merchant 106 when the vehicle identity is involved in financial transactions, and a financial institution computing system 130 via a network 132. In some arrangements, the network interface 114 includes the hardware and logic necessary to communicate over multiple channels of data communication. For example, the network interface 114 may include a cellular modem, a Bluetooth transceiver, a Bluetooth beacon, an RFID transceiver, and an NFC transmitter. Data passing through the network interface 114 may be encrypted such that the network interface 114 is a secure communication module. The occupant identity system 108 includes a display 116 and a user input 118. In some arrangements, the display 116 and the user input 118 are combined in the form of a touchscreen device. The display 116 and the user input 118 may also function as the display and user inputs of the infotainment system. The occupant identity system 108 further includes sensors 120. The sensors 120 may include any of location sensors (e.g., GPS, GLONAS, wireless location services, etc.) and vehicle occupancy sensors (e.g., cameras, motion detectors, seat pressure sensors, wireless receivers, etc.). The sensors 120 may include other sensors including accelerometers, gyroscopic sensors, and various biometric sensors. In arrangements where the occupant identity system 108 is connected to the ECU of the vehicle 104, there is additional access to the throttle position sensor, engine coolant temperature sensor, air flow meter, air-fuel ratio meter, crankshaft position sensor. In addition, if present in the vehicle, there is access through the ECU to remote start mechanisms, indicator lights, on-board diagnostics, etc.

The occupant identity system 108 facilitates payment to the merchant 106 based on the vehicle as a singular merged identity based at least in part on the specific occupants 102 in the vehicle 104. The merchant 106 provides goods and/or services to the vehicle 104 and/or to the occupants 102. Accordingly, the occupant identity system 108 includes identity logic which comprises identity information 124. The identity information may include financial information pertaining to the occupants 102. The financial information can be stored in the memory 112 of the occupant identity system 108 or provided by the occupants 102 at the time of identification (e.g., transmitted from an occupant device such as a smart phone, manually entered into the occupant identity system 108 via the user input 118, etc.). The identity logic 122 is programmed or built into the occupant identity system 108 and allows for the storage, selection, and transmission of identity information 124. The identity information 124 may be used to authorize or authenticate occupants in or in proximity of the vehicle 104. The identity information 125 may be used along with an additional information to determine the purpose of the vehicle trip (e.g. business, personal, etc.), and thus, the vehicle identity. The additional information may include an electronic calendar associated with the occupants 102 or the owner of the vehicle 104 (e.g., a business calendar), electronic appointment book, or the like.

The identity information 124 may include user identification information (e.g., user login information, identification tokens, etc.) and payment sources associated with users identified by the user identification information. The payment sources include any of credit card information, debit card information, bank account information, mobile wallet information, or the like. In some arrangements, the identity logic 122 is programmed with a default payment source. For example, the identity logic 122 can be programmed with payment information relating to the owner or primary user of the vehicle 104. The owner's or primary user's payment information may be used as a default payment source for purchases made from a merchant 106 or for payment for other services (e.g., tolls). The identity logic 122 allows for new payment sources to override the default payment source. For example, as described in further detail below, the identity logic may be programmed with new payment sources relating to various occupants 102 that are actually in the vehicle 104 as opposed to the owner or primary user that is not present in the vehicle 104. The identity logic 122 may further allow for the sharing of costs amongst multiple payment sources (e.g., one payment source for each occupant 102), including the default payment method. The identity logic 122 can be programmed with multiple payment sources for different types of expenses (e.g., a first payment source for fuel, a second payment source for tolls, etc.). The identity logic 122 can select different payment sources based on location information received from the sensors 120. For example, a specific payment method may be programmed to be valid only in specific locations (e.g., inside of Seattle). The identity logic 122 can be programmed such that a payment source expires after a set duration (e.g., after two hours). The identity logic 122 can also detect when a new payment source entering the vehicle 104 and prompt the occupants 102 for override instructions. The identity logic 122 can facilitate a car sharing service that allows authorized occupants 102 the use of the vehicle 104. These and other use cases are described in further detail below.

The system 100 may include a merchant payment terminal 128 associated with the merchant 106. The merchant payment terminal 128 includes a processor 134, a memory 136, and a network interface 138. The memory 136 stores programming modules that, when executed by the processor 134, control the operation of the payment terminal 128. In some arrangements, the network interface 138 includes the hardware and logic necessary to communicate over multiple channels of data communication. For example, the network interface 138 includes any of a cellular modem, a Bluetooth transceiver, a Bluetooth beacon, an RFID transceiver, and/or an NFC transmitter. Data passing through the network interface 114 may be encrypted such that the network interface 114 is a secure communication module. The data passing through network interface 114 may be financial payment information which is then communicated through the network 132 to a financial institution computing system 130 to facilitate payment for goods or services.

Still referring to FIG. 1, the system 100 includes a financial institution computing system 130 associated with a financial institution (e.g., a bank, a credit card issuer, etc.). The financial institution computing system 130 includes a processor 140, a memory 142, a network interface 144, an account database 146, and an identity database 148. The memory 142 stores programming modules that, when executed by the processor 140, control some operations of the financial institution computing system 130. Data passing through the network interface 144 may be encrypted such that the network interface 114 is a secure communication module. The financial institution computing system 130 may communicate to the payment terminal 128 of the merchant 106 in order to approve payment for financial transactions. The account database 146 may store information relating to a plurality of financial account maintained by the financial institution. The identity database 148 may store one-time use or temporary numbers used in financial transactions tied to a vehicle profile. These may be in the form of virtual accounts. The identity database 148 may store vehicle profiles comprising merged identities of one or more occupants of a vehicle. These merged identities may be linked to vehicle profiles determined by various criteria including occupant(s) using the vehicle 104 for business purposes, occupant(s) using the vehicle 104 for personal and family purposes, occupant(s) using the vehicle for other specifically defined travel purposes, etc. One or both of the account database 146 and the identity database 148 may store and link the serial numbers associated with an occupant identity system 108 to accounts or virtual accounts stored in the databases.

In the system 100, data communication between the occupant identity system 108, the occupants 102, the payment terminal 128, and the financial institution computing system 130 may be facilitated by the network 132. In some arrangements, the network 132 includes the internet.

Still referring to FIG. 1, the occupants 102 of the vehicle 104 may have their own personal electronic devices. The personal electronic devices may be, for example, smartphones, tablet computers, personal media players, or the like. Accordingly, the personal electronic devices have the necessary hardware and software to communicate data to the occupant identity system 108 and over the network 132. The personal electronic devices may communicate to the occupant identity system 108 in various ways known in the art, including via NFC, Bluetooth, Wi-Fi, or the like. The personal electronic devices may store or have access to financial information relating to the occupants 102. For example, the personal electronic devices may be used by the occupants to access financial information relating to accounts held with a financial institution by accessing the financial institution computing system 130 via mobile wallets or websites. Each personal electronic device may emit wireless signals at different frequencies such that each occupant device can be identified by the occupant identity system 108 and determined to be in or near the vehicle 104.

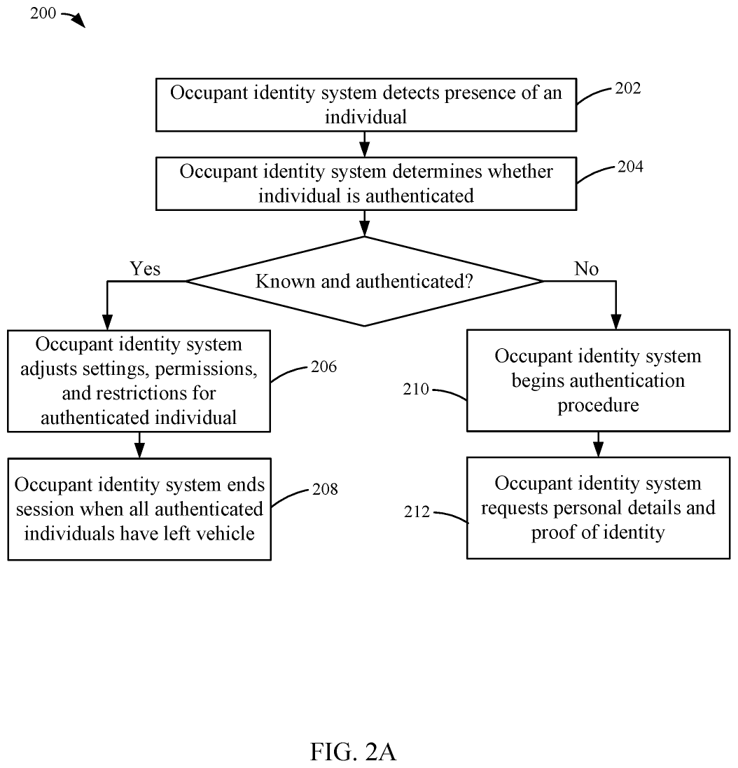

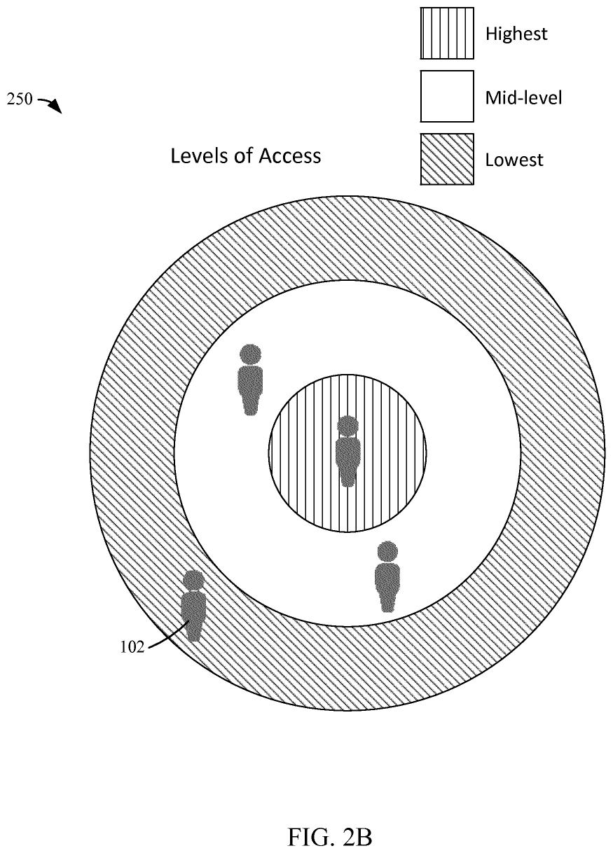

The general operation of the occupant identity system 108 of the vehicle 104 within the system 100 is described in further detail below with respect to FIGS. 2A through 5.

Referring now to FIG. 2A, a flow diagram of a method 200 of authenticating an individual who has entered the vehicle 104 is shown according to an example embodiment. Method 200 is performed by the processor 110 and identity logic 122 of the occupant identity system 108. Method 200 begins with the occupant identity system 108 detecting the presence of an individual at 202. The individual has entered the vehicle 104 or is in near proximity. Detecting the presence of an individual may be made in various ways including door sensors, proximity sensors, detection of RFID keys (e.g., a key used to unlock and start the vehicle 104), RFID or NFC enabled user devices, and the like. The occupant identity system 108 determines whether the individual is a known or authenticated individual or an unknown individual at 204. Authentication may take place in various ways including verification of RFID keys, RFID or NFC enabled mobile devices, the use of biometrics, inputting of a PIN or pass-code, etc. Authentication may be done by way of two-factor or multiple-factor authentication. If the individual is a known and authenticated individual, the occupant identity system 108 adjusts settings to various permissions and/or restrictions at 206 based on the presence and specific identity of the individual. Permissions and restrictions may relate to access to any infotainment functionality, access to the network, access to GPS navigation, the amount of information shown on the occupant identity system, seat positions, steering wheel positions, climate control settings, radio preferences, and the like. The exiting of the vehicle 104 by the individual ends the session at 208. The detection of vehicle exit may be accomplished by various means including door opening sensors, seat weight sensors, motion sensors, proximity sensors, etc. In some arrangements, the vehicle 104 maintains a history of individuals that have been authenticated by the vehicle 104. This history may contain at least date, time, and duration information. Other information is stored and maintained along with the identity of the user including fuel use, infotainment use, vehicle location, stored financial information use, sensor information recording wear and tear on the vehicle, acceleration and deceleration metrics, and the like.

Continuing with FIG. 2A, if the individual is unknown or unable to be authenticated, the method 200 begins an authentication procedure at 210. During the authentication procedure at 210, in some arrangements the occupant identity system 108 receives personal details of the unknown or unauthenticated individual. These personal details include name, address, driver's license number, social security number, and the like. For example, the unknown or unauthenticated individual may not have previously registered with the occupant identity system 108 or the owner of the vehicle 104. The occupant identity system 108 is be able to read or scan a bar code, magnetic strip, or RFID or NFC enabled microchip on a driver's license or other identification card or analyze a received image of the driver's license or other identification card in order to authenticate the individual. In an alternate embodiment, the occupant identity system 108 receives the personal details of the unknown or unauthenticated individual via data that is being entered into a mobile device of the occupant that is in communication with the occupant identity system 108 or via the user input 118. The communication between the occupant identity system 108 and the individual's mobile device is through RFID, NFC, secure Wi-Fi, Bluetooth, etc.

Finally, as part of the authentication procedure, the occupant identity system 108 requests personal details that may have to be combined with a proof of identity at 212 to finish authentication in some arrangements. Personal details are biographical information, financial information details, credit report details, etc. Personal details may also include biometric data (e.g. fingerprint scan, iris or retina scan, facial features, voice features). In some arrangements, the personal details along with any biometric data are stored indefinitely in the occupant identity system 108. In other arrangements, the personal details and related data can be set to expire or be deleted after a set period of time or upon certain inputs (e.g., at the request of the user associated with the personal details and biometric data, at the request of the vehicle owner, etc.). The personal details and related data may expire and no longer be valid for authorized use of the vehicle, but remain stored on the system. The set period of time can be a time period, e.g., hour, day, week, or a set period of time coupled to an event, e.g., the duration of a trip or the duration of a rental period. The set period of time can be based on certain inputs, e.g., expiration upon individual exiting the car, expiration upon a new, different user being authorized, expiration upon returning to a certain geographical area, etc.

The authentication procedure at 210 along with the request for personal details and proof of identity at 212 allow the vehicle 104 to store enough data on the individual to recognize the individual when the individual subsequently enters the vehicle 104. In another alternate embodiment, the occupant identity system 108 allows for a security setting that sets off an alarm and/or informs security, authorities, or a security center when an unknown individual has entered the vehicle 104 and cannot be authenticated. In some arrangements, the vehicle 104 prevents vehicle ignition, prevents placing the transmission into gear, or otherwise activates a ‘kill switch’ or other disabling function to prevent unauthorized use by the unknown and unauthenticated individual.

A level of access is determined based on the identity of the authenticated individual in some arrangements. There are different access levels available that offer greater or lesser amounts of information or access to features of the vehicle 104 to individual occupants. In one embodiment, the access is based on the most restricted level of access of each respective individual in the vehicle 104. The presence of an unauthenticated individual corresponds with no access or the most restricted level of access. The level of access in some embodiments can be visualized as rings with the users in the central ring given full access. Referring now to FIG. 2B, one embodiment 250 of the level of access visualized as concentric rings is depicted. Individuals in rings further from the center have progressively more restricted access. Access levels affect the amount of information available to the individuals, such as the amount of vehicle information shown on the display screen, payment options available to the occupants, access to change vehicle settings, and the like. Access levels also determine occupant vehicle control options. The control options include access to various car options, the infotainment system, ECU access, network access, etc. Access levels further determine access to features, configuration settings, and storage compartments on the vehicle 104 itself. In some arrangements, restrictions are applied to level of control available while driving the vehicle 104. These restrictions may impose a speed limit or a geographical limitation or other restrictions on driving the vehicle 104. The restrictions may be a hard restriction which actually prevents exceeding the set speed limit or leaving the geographical area for example. The restrictions may be a soft restriction that does not prevent exceeding the restriction, but creates an audible or visual alert as well as sending an alert over the network. Exceeding the soft restrictions may also reduce the level of access of the individuals in the vehicle. For example, driving the vehicle 104 out of a restricted geographical area may cause restriction of access to the infotainment system. In some arrangements, access levels are set via user input for unauthenticated users. For example, the vehicle 104 is put in a ‘valet’ mode, where there is no requirement of authentication of the occupant of the vehicle 104, but very minimal or no access is granted to information displayed on the occupant identity system 108 or access given to other car features. In another example, the vehicle 104 is loaned out to an individual who is borrowing the vehicle 104 for a period of time. The access level is set to a determined level of access appropriate for use while the car is borrowed or alternately, the borrower is set up as an authorized user that can be authenticated by the occupant identity system 108 with a determined level of access.

Returning to FIG. 2A, in another embodiment, the method 200 iterates two or more times in order to authenticate multiple individuals present in the vehicle 104. This results in a vehicle 104 having an identity that is composed of the multiple identities of the individuals authenticated by the occupant identity system 108. For example, there may be a family identity when two or more members of the same family are authenticated as being in the vehicle 104. As a further example, there may be a business identity when two or more members of the same company are authenticated in the vehicle 104, etc. In situations in which multiple individual identities comprise the vehicle identity, costs may be shared amongst multiple different payment sources associated with the individuals in the vehicle 104.

In another embodiment, the vehicle 104 is part of a vehicle sharing service. As part of a sharing service, an individual desires to temporarily use the vehicle 104. The vehicle 104 identifies the individual as an unauthenticated individual and requests further information on identity. The individual then enters input that allows the vehicle 104 to create a profile and account for the individual. In some arrangements, such input includes identification information, biometric sensor input, visual image from camera, payment information, etc. Once the individual has a profile and has created an identity, the individual in future visits is identified as an authenticated individual. Other authentication methods as described above may also be used.

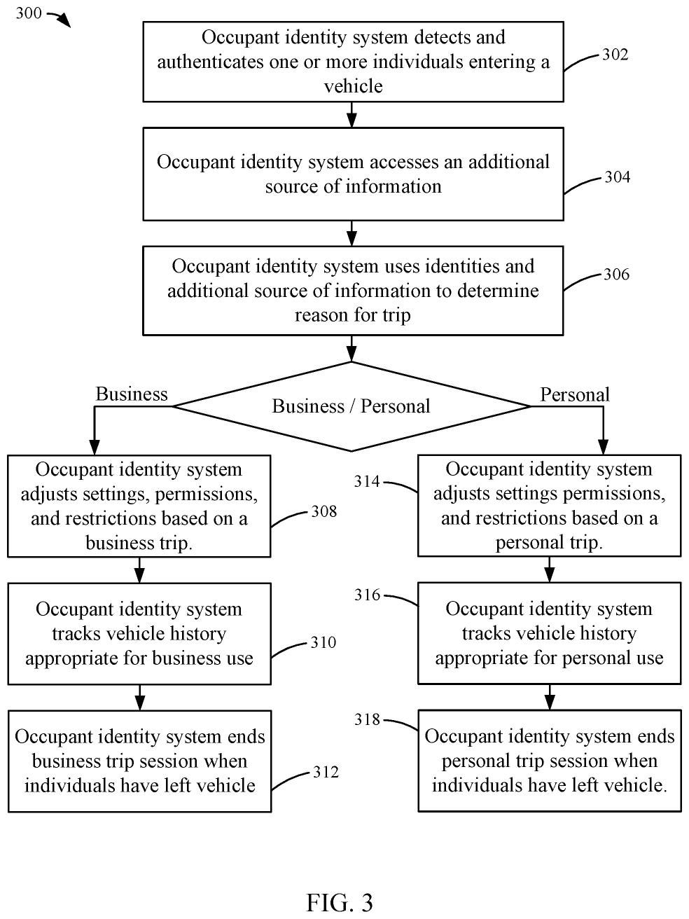

Referring now to FIG. 3, a flow diagram of a method 300 of detecting the purpose of a vehicle trip is shown according to an example embodiment. Method 300 is performed by the processor 110, identity logic 122, and memory 112 of the occupant identity system 108. Method 300 begins with the occupant identity system 108 detecting and authenticating one or more individuals entering the vehicle 104 at 302. Authentication occurs through an authentication method, such as the method 200 as described above with respect to FIGS. 2A and 2B. The occupant identity system 108 accesses an additional source of information regarding the reason for embarking in the vehicle 104 at 304. One or more of various additional sources of information are accessed including electronic calendars, appointment books, emails, social media, a company server, etc. The sources of information are stored in the memory 112 of the occupant identity system 108. Alternately, the sources of information are accessed through the network interface 114 of the occupant identity system 108. The occupant identity system 108 uses the identity of the individuals along with the additional source of information to determine if the trip is for business reasons or personal reasons at 306. Alternately, the occupant identity system 108 sends the identity information out through the network interface 114 and receives back information regarding the reason for the trip. Alternately, the occupant identity system 108 sends the identity information along with the data from the additional sources of information out through the network interface 114 and receives back information regarding the reason for the trip.

In one example, a business uses the vehicle 104 as a business vehicle, and an individual uses the same vehicle 104 for personal use. Accordingly, the vehicle 104 is used for mixed business and personal use. The occupant identity system 108 tracks the vehicle 104 history for both business and any personal use including individuals using the vehicle 104 and keeps a history of the mileage used and any expenses incurred. Other historical data from the vehicle systems and sensors connected to the occupant identity system 108 is stored. In some arrangements, this data includes sensor information recording wear and tear on the vehicle 104, acceleration and deceleration metrics and the like. When an occupant identity system 108 determines the trip is being made for business reasons, the occupant identity system 108 adjusts settings, permissions, and restrictions based on a business trip at 308. Examples of settings, permissions, and restrictions include enabling fuel economy mode of the vehicle 104, restricting or allowing access to an infotainment system, restricting or allowing access to ECU settings, GPS tracking, restricting categories where cost may be incurred, changing payment sources, etc. The device then tracks vehicle history appropriate for business use at 310 and ends the session when the individuals have left the vehicle 104 at 312. When an occupant identity system 108 determines the trip is being made for personal reasons, the occupant identity system 108 adjust settings, permissions, and restrictions based on a personal trip at 314. The occupant identity system 108 then tracks vehicle history appropriate for personal use at 316 and ends the session when the individuals have left the vehicle 104 at 318. The vehicle history tracked at 316 can include, for example, expense reports, fuel usage reports, passenger identities during the history, and the like. The vehicle history can be transmitted by the occupant identity system 108 to an external device, such as a user device or a company server for record keeping.

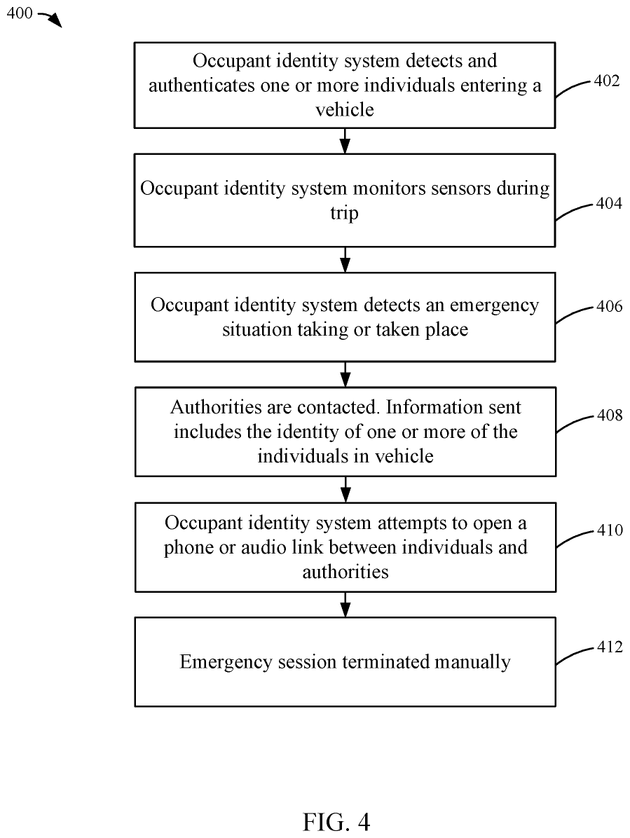

Referring now to FIG. 4, a flow diagram of a method 400 of contacting emergency services by an occupant identity system 108 is shown according to an example embodiment. Method 400 is performed by the processor 110 and identity logic 122 of the occupant identity system 108. Method 400 begins with the occupant identity system 108 detecting and authenticating one or more individuals entering the vehicle 104 at 402. The occupant identity system 108 then monitors sensors during the trip at 404 or while the vehicle 104 is turned on or in motion. The occupant identity system 108 detects when an emergency situation is taking place or has taken place at 406. In some arrangements, emergency situations are situations where airbags have deployed or when a vehicle accident is detected by other means such as vehicle sensors (e.g., accelerometer sensors, crush sensors, contact sensors, or other sensors), sensors monitoring biometric data relating to the occupants, etc. The occupant identity system 108 then alerts authorities at 408 by calling an emergency number directly or alerting authorities through other means such as a central call or data center. Due to the occupant identity system 108 containing a vehicle identity consisting of the identities of those present in the vehicle 104, the identity information can be passed along to the authorities. In some arrangements, other relevant data gathered from the sensors, including biometric or other physical condition data of the individuals, is passed on to authorities. Such data may include heart rate of occupants, breathing rate of occupants, interior and exterior temperature readings, air bag deployment status, the status of crush or contact sensors that have been activated, gyroscopic sensor information indicating flipped vehicle, etc. The data related to the identities and other relevant data may be sent for just the driver of the vehicle 104 or of all occupants of the vehicle 104. This information can be used by emergency teams (e.g., police, fire fighters, paramedics, etc.) to assist in responding to an emergency involving the vehicle 104, such as a crash. Alternately, the occupant identity system 108 attempts to set up an audio link directly from the individuals in the vehicle 104 to the authorities at 410 and alert the individuals that they may now speak directly to the authorities. In some arrangements, an audio link directly from the individuals to authorities may be attempted to be set up and only if there is failure of the audio link or no detected speaking from individuals in the vehicle is the identity information and sensor data related to the individuals sent to authorities. The emergency session can be terminated manually at 412 once the situation has been resolved.

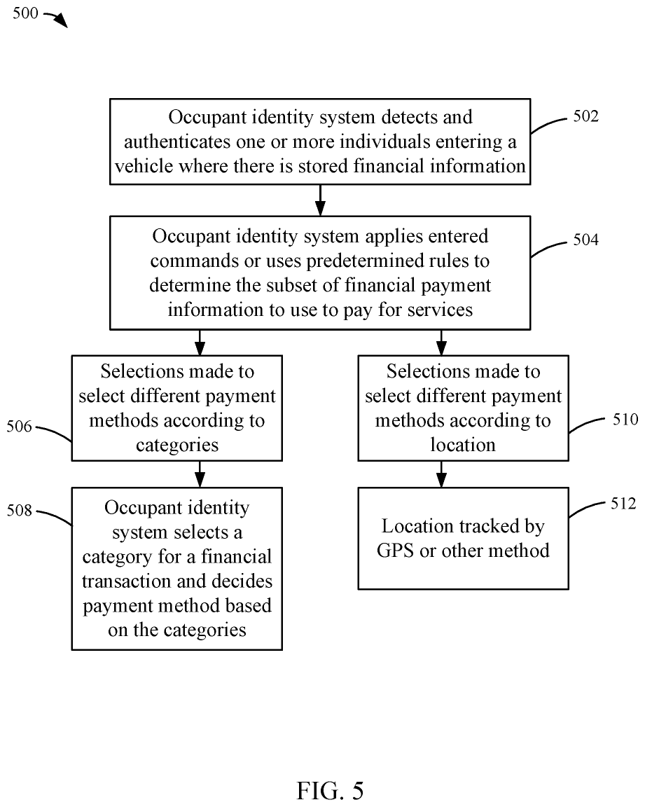

Referring now to FIG. 5, a flow diagram of a method 500 of sharing costs incurred in a vehicle is shown according to an example embodiment. Method 500 is performed by the processor 110 and identity logic 122 of the occupant identity system 108. Method 500 begins with the occupant identity system 108 detecting and authenticating one or more individuals entering the vehicle 104 for which there is authorization to store financial payment information at 502. In some arrangements, manual payment information is also entered for any individual that is present and authorized but with no stored financial payment information. The financial information is entered into the occupant identity system 108 through a touchscreen interface. Other methods may be used such as a credit card reader, communication with a mobile wallet, and the like. Various sensors and accessories attached to the occupant identity system 108 are used to enter new financial information (e.g., a credit card magnetic stripe reader, smart chip reader, etc.).

Continuing with FIG. 5, the occupant identity system 108 determines the subset of financial payment information available to use to pay for services at 504. Services may be incurred costs due to the use of the vehicle 104 as well as the purchase of goods while traveling in the vehicle 104. In some arrangements, the occupant identity system 108 applies either entered commands or predetermined rules to determine what subset of financial payment information contained in the occupant identity system 108 is used to pay for services associated with the use of the vehicle 104 at 504. Various options are presented to the user(s) to share future payments in the vehicle 104. One possible option is to select different payment methods for expenses involving the vehicle 104 according to categories at 506. Categories include toll-way expenses, fuel expenses, drive-thru expenses, etc. When there is a cost incurred, the occupant identity system 108 selects a category for the financial transaction and decides the payment method based on the category at 508. The category is selected by accessing a database, prompting the user(s), etc.

In another embodiment, different payment methods may be selected for expenses according to the current location of the vehicle 104 at 510. For example, the user sets a payment method to be used when within the city of Seattle. The location of the vehicle 104 or vehicle 104 is tracked by GPS or other method using the location services of the occupant identity system 108 at 512. In some arrangements, selection of the financial payment information is based upon detecting the purpose of the vehicle trip based upon the identity of the individuals detected. Various additional sources of information may be accessed including electronic calendars, appointment books, emails, etc. in order to determine the reason for the trip such as if it is for business reasons, personal reasons, etc. In some embodiments the sensors are configured to determine the identity of the driver of the vehicle to differentiate from the passengers in the vehicle. The vehicle tracks the payment history and categorizes by both business and any personal use including individuals using the vehicle. In either case, after 508 or 512, the occupant identity system 108 can transmit payment information to a payment terminal 128.

The embodiments of the present invention have been described with reference to drawings. The drawings illustrate certain details of specific embodiments that implement the systems and methods and programs of the present invention. However, describing the invention with drawings should not be construed as imposing on the invention any limitations that may be present in the drawings. The present invention contemplates methods, systems and program products on any machine-readable media for accomplishing its operations. The embodiments of the present invention may be implemented using an existing computer processor, or by a special purpose computer processor incorporated for this or another purpose or by a hardwired system.

As noted above, embodiments within the scope of the present invention include program products comprising machine-readable media for carrying or having machine-executable instructions or data structures stored thereon. Such machine-readable media can be any available media that can be accessed by a general purpose or special purpose computer or other machine with a processor. By way of example, such machine-readable media can comprise RAM, ROM, EPROM, EEPROM, CD-ROM or other optical disk storage, magnetic disk storage or other magnetic storage devices, or any other medium which can be used to carry or store desired program code in the form of machine-executable instructions or data structures and which can be accessed by a general purpose or special purpose computer or other machine with a processor. Combinations of the above are also included within the scope of machine-readable media. Machine-executable instructions comprise, for example, instructions and data which cause a general purpose computer, special purpose computer, or special purpose processing machines to perform a certain function or group of functions.

Embodiments of the present invention have been described in the general context of method steps which may be implemented in one embodiment by a program product including machine-executable instructions, such as program code, for example in the form of program modules executed by machines in networked environments. Generally, program modules include routines, programs, objects, components, data structures, etc. that perform particular tasks or implement particular abstract data types. Machine-executable instructions, associated data structures, and program modules represent examples of program code for executing steps of the methods disclosed herein. The particular sequence of such executable instructions or associated data structures represent examples of corresponding acts for implementing the functions described in such steps.

As previously indicated, embodiments of the present invention may be practiced in a networked environment using logical connections to one or more remote computers having processors. Those skilled in the art will appreciate that such network computing environments may encompass many types of computers, including personal computers, hand-held devices, multi-processor systems, microprocessor-based or programmable consumer electronics, network PCs, minicomputers, mainframe computers, and so on. Embodiments of the invention may also be practiced in distributed computing environments where tasks are performed by local and remote processing devices that are linked (either by hardwired links, wireless links, or by a combination of hardwired or wireless links) through a communications network. In a distributed computing environment, program modules may be located in both local and remote memory storage devices.

An example system for implementing the overall system or portions of the invention might include a general purpose computing computers in the form of computers, including a processing unit, a system memory, and a system bus that couples various system components including the system memory to the processing unit. The system memory may include read only memory (ROM) and random access memory (RAM). The computer may also include a magnetic hard disk drive for reading from and writing to a magnetic hard disk, a magnetic disk drive for reading from or writing to a removable magnetic disk, and an optical disk drive for reading from or writing to a removable optical disk such as a CD ROM or other optical media. The drives and their associated machine-readable media provide nonvolatile storage of machine-executable instructions, data structures, program modules and other data for the computer. It should also be noted that the word “terminal” as used herein is intended to encompass computer input and output devices. Input devices, as described herein, include a keyboard, a keypad, a mouse, joystick or other input devices performing a similar function. The output devices, as described herein, include a computer monitor, printer, facsimile machine, or other output devices performing a similar function.

It should be noted that although the diagrams herein may show a specific order and composition of method steps, it is understood that the order of these steps may differ from what is depicted. For example, two or more steps may be performed concurrently or with partial concurrence. Also, some method steps that are performed as discrete steps may be combined, steps being performed as a combined step may be separated into discrete steps, the sequence of certain processes may be reversed or otherwise varied, and the nature or number of discrete processes may be altered or varied. The order or sequence of any element or apparatus may be varied or substituted according to alternative embodiments. Accordingly, all such modifications are intended to be included within the scope of the present invention as defined in the appended claims. Such variations will depend on the software and hardware systems chosen and on designer choice. It is understood that all such variations are within the scope of the invention. Likewise, software and web implementations of the present invention could be accomplished with standard programming techniques with rule based logic and other logic to accomplish the various database searching steps, correlation steps, comparison steps and decision steps.

The foregoing description of embodiments of the invention has been presented for purposes of illustration and description. It is not intended to be exhaustive or to limit the invention to the precise form disclosed, and modifications and variations are possible in light of the above teachings or may be acquired from practice of the invention. The embodiments were chosen and described in order to explain the principals of the invention and its practical application to enable one skilled in the art to utilize the invention in various embodiments and with various modifications as are suited to the particular use contemplated. Other substitutions, modifications, changes and omissions may be made in the design, operating conditions and arrangement of the embodiments without departing from the scope of the present invention as expressed in the appended claims.

1. A vehicle occupant identity system for use with a vehicle, the system comprising:
a network interface;
a computer memory, the computer memory storing identity information;
a display, wherein the display is used to provide visual information to operators of the vehicle; and
one or more processors executing operations, the executed operations causing the vehicle system to:
detect a presence of an individual within the vehicle,
determine an identity of the individual based at least in part on the identity information,
receive additional information via the network interface from a device associated with the individual,
identify a purpose for a trip in the vehicle using the additional information, comprising, based on the additional information, automatically set the purpose of the trip to one of business use and personal use after detecting the presence of the individual within the vehicle, and
configure at least one setting of the vehicle based on the purpose of the trip and the identity of the individual, comprising:
based on the purpose of the trip, determining a plurality of payment sources to be used by the vehicle for expenses occurred during the trip,
for each of the plurality of payment sources, determining allowable expense categories, and
generating a restriction comprising at least one payment source from the plurality of payment sources, wherein the expenses incurred using the at least one payment source are limited to the allowable expense categories.

2. The system of claim 1, wherein the one or more processors causes the vehicle system to authenticate the individual by communicating with a mobile device associated with the individual.

3. The system of claim 1, further comprising a touchscreen, wherein the one or more processors further executes operations to authenticate the individual using data received from the touchscreen.

4. The system of claim 1, wherein the source of the additional information is selected from a group consisting of an electronic calendar and an electronic appointment book.

5. The system of claim 1, wherein the one or more processors further execute operations to:
detect an emergency situation; and
transmit information comprising the existence of the emergency situation.

6. The system of claim 5, wherein the information transmitted further comprises the identity of the individual.

7. The system of claim 1, wherein the one or more processors further execute operations to:
detect a presence of a second individual;
authenticate the second individual; and
create a merged identity comprising the identity of the individual and the second individual.

8. (canceled)

9. The system of claim 1, wherein the setting of the vehicle relates to fuel economy mode of the vehicle or an infotainment setting of the vehicle.

10. A method of using a vehicle occupant identity system in a vehicle, the method comprising:
detecting, by a processor of an occupant identity system, a presence of an individual within the vehicle;
determining an identity of the individual based at least in part on stored identity information;
receiving additional information via a network interface from a device associated with the individual;
identifying a purpose for a trip in the vehicle using the additional information, comprising, based on the additional information, automatically setting the purpose of the trip to one of a business use and a personal use after detecting the presence of the individual within the vehicle, and
configuring at least one setting of the vehicle based on the purpose of the trip and the identity of the individual, comprising:
based on the purpose of the trip, determining a plurality of payment sources to be used by the vehicle for expenses occurred during the trip,
for each of the plurality of payment sources, determining allowable expense categories, and
generating a restriction comprising at least one payment source from the plurality of payment sources, wherein the expenses incurred using the at least one payment source are limited to the allowable expense categories.

11. The method claim 10, further comprising authenticating the individual by communicating with a mobile device associated with the individual.

12. The method of claim 10, further comprising authenticating the individual by using data received from a touchscreen.

13. The method claim 10, wherein the source of the additional information is selected from a group consisting of an electronic calendar and an electronic appointment book.

14. The method of claim 10, the method further comprising:
detecting an emergency situation; and
transmitting information comprising the existence of the emergency situation.

15. The method of claim 14, wherein the information transmitted further comprises the identity of the individual.

16. (canceled)

17. The method of claim 10, wherein the setting of the vehicle relates to fuel economy mode of the vehicle or an infotainment setting of the vehicle.

18. A non-transitory computer-readable media having computer-executable instructions embodied therein that, when executed by one or more processors of a vehicle occupant identity system for use with a vehicle, cause the system to perform a process, the process including:
detecting, by a processor of an occupant identity system, a presence of an individual within the vehicle;
determining an identity of the individual based at least in part on stored identity information;
receiving additional information via a network interface from a device associated with the individual;
identifying a purpose for a trip in the vehicle using the additional information, comprising, based on the additional information, automatically setting the purpose of the trip to one of a business use and a personal use after detecting the presence of the individual within the vehicle, and
configuring at least one setting of the vehicle based on the purpose of the trip and the identity of the individual, comprising:
based on the purpose of the trip, determining a plurality of payment sources to be used by the vehicle for expenses occurred during the trip,
for each of the plurality of payment sources, determining allowable expense categories, and
generating a restriction comprising at least one payment source from the plurality of payment sources, wherein the expenses incurred using the at least one payment source are limited to the allowable expense categories.

19. The non-transitory computer-readable media of claim 18, wherein the process further includes authenticating the individual by communicating with a mobile device associated with the individual.

20. The non-transitory computer-readable media of claim 18, wherein the process further includes authenticating the individual by using data received from a touchscreen.

21. The non-transitory computer-readable media of claim 18, wherein the source of the additional information is selected from a group consisting of an electronic calendar and an electronic appointment book.

22. The non-transitory computer-readable media of claim 18, wherein the process further includes:
detecting an emergency situation; and
transmitting information comprising the existence of the emergency situation.

23. The non-transitory computer-readable media of claim 22, wherein the information transmitted further comprises the identity of the individual.

24. (canceled)

25. The non-transitory computer-readable media of claim 18, wherein the setting of the vehicle relates to fuel economy mode of the vehicle or an infotainment setting of the vehicle.

26. A method of using a vehicle occupant identity system in a vehicle, the method comprising:
detecting, by a processor of an occupant identity system, a presence of an individual within the vehicle;
determining an identity of the individual based at least in part on stored identity information;
identifying a purpose for a trip in the vehicle using additional information provided by a device associated with the individual, comprising, based on the additional information, automatically setting the purpose of the trip to one of a business use and a personal use after detecting the presence of the individual within the vehicle, and
configuring a restriction based on the identity of the individual and the purpose for the trip, comprising:
based on the purpose of the trip, determining a plurality of payment sources to be used by the vehicle for expenses occurred during the trip,
for each of the plurality of payment sources, determining allowable expense categories, and
generating the restriction comprising at least one payment source from the plurality of payment sources, wherein the expenses incurred using the at least one payment source are limited to the allowable expense categories.

27. The method claim 26, further comprising authenticating the individual by communicating with a mobile device associated with the individual.

28. The method of claim 26, further comprising authenticating the individual by using data received from a touchscreen of the occupant identity system.

29. The method of claim 26, further comprising receiving additional information via a network interface from a device associated with the individual.

30. The method claim 29, wherein the source of the additional information is selected from a group consisting of an electronic calendar and an electronic appointment book.

31. (canceled)

32. The method of claim 26, the method further comprising:
detecting an emergency situation; and
transmitting information comprising the existence of the emergency situation.

33. The method of claim 26, wherein the information transmitted further comprises the identity of the individual.

34. The method of claim 26, further comprising configuring a setting of the vehicle based at least in part on the identity of the individual.

35. The method of claim 34, wherein the setting of the vehicle relates to fuel economy mode of the vehicle or an infotainment setting of the vehicle.

36. The method of claim 26, wherein the individual is a first individual, the method further comprising changing the payment source from a default payment source associated with a second individual to a first payment source associated with the first individual, wherein the at least one payment source associated with the restriction is the first payment source.

37. The method of claim 36, further comprising:
determining, by the processor, that the first individual has left the vehicle; and
reverting the first payment source to the default payment source.
